(19) United States
(12) Patent Application Publication
(10) Pub. No.: US 2009/0142623 A1
(43) Pub. Date: Jun. 4, 2009

(54) MAGNETIC RECORDING MEDIUM AND METHOD FOR PRODUCING THE SAME

(75) Inventors: Nobuhiro JINGU, Tokyo (JP); Mamoru Satoh, Tokyo (JP); Kenichi Kitamura, Tokyo (JP); Megumi Yoshimura, Tokyo (JP)

Correspondence Address: DRINKER BIDDLE & REATH (DC), 1500 K STREET, N.W., SUITE 1100, WASHINGTON, DC, 20005-1209, US

(73) Assignee: TDK Corporation, Chuo-ku (JP)

(21) Appl. No.: 12/276,733

(22) Filed: Nov. 24, 2008

(30) Foreign Application Priority Data
Nov. 30, 2007 (JP) P2007-311365

(51) Int. Cl. G11B 5/708

(52) U.S. Cl. 428/842.2

(57) ABSTRACT

The present invention provides a magnetic recording medium capable of obtaining high recording density and also having a hardly charged magnetic layer. The magnetic recording tape 2 (magnetic recording medium) of a preferable embodiment has a magnetic layer 6 containing a SmCo magnetic fine particle 12 and a hydrophilic binder, wherein the SmCo magnetic fine particle 12 has a core 14 made of a SmCo nano particle and a coating layer 16 made of a hydrophilic polymer and coating at least a part of a surface of the core 14.

### BACKGROUND OF THE INVENTION

1. Field of the Invention

The present invention relates to a magnetic recording medium and a production method thereof.

2. Related Background Art

A magnetic recording tape that is one kind of magnetic recording media is generally composed of a base film, a magnetic layer formed on one surface of the base film, and a back coat layer formed on the other surface of the base film. The magnetic layer is a layer containing a magnetic material, a binder (resin material), and the like, and the back coat layer is a layer containing a nonmagnetic powder such as carbon black, a binder, and the like. In recent years, in order to deal with progress in the IT society as shown in introduction of a SOX method, an e-document method, etc., long-term storage and high recording density of magnetic recording media have been required.

As an example of a magnetic material containing a magnetic layer of a magnetic recording medium, Japanese Patent Application Laid-Open No. 2006-245313 discloses a SmCo magnetic fine particle made of a SmCo alloy. The SmCo alloy shows extremely high uniaxial crystal magnetic anisotropy, and is thus preferable as a magnetic material for a magnetic recording medium that achieves high recording density.

### SUMMARY OF THE INVENTION

Meanwhile, in recent years, in order to deal with high density recording, readout of date recorded in a magnetic recording tape, and the like are performed by using a magnetic resistance effect (MR) head. However, such a MR head is easily affected by electrostatic charged on the magnetic recording tape, and if this effect is large, correct readout cannot be performed in some cases. Therefore, a magnetic layer constituting the magnetic recording tape is required to achieve high recording density, and at the same time, to have characteristics of being hardly electrostatistically charged as much as possible.

Accordingly, the present invention was made in view of such circumstances, and an object of the invention is to provide a magnetic recording medium capable of obtaining high recording density, and in addition, having a hardly charged magnetic layer, and a production method thereof.

In order to achieve the above object, the magnetic recording medium of the present invention has a magnetic layer containing a SmCo magnetic fine particle and a hydrophilic binder and characterized in that the SmCo magnetic fine particle has a core made of a SmCo nano particle and a coating layer made of a hydrophilic polymer and formed to coat at least a part of the surface of the core. Herein, the SmCo nano particle in the present invention refers to a particle composed of a SmCo alloy and having an average particle diameter of 1 nm or more and less than 100 nm.

A magnetic layer in the magnetic recording medium of the present invention has a structure in which SmCo magnetic fine particles are dispersed in a hydrophilic binder. Since this hydrophilic binder is hardly electrostatically charged as it is, the magnetic layer is hardly electrostatically charged as a whole. Therefore, according to the magnetic recording medium of the present invention, for example, readout by a MR head can be stabilized.

Since the SmCo magnetic fine particle contained in the magnetic layer has a structure in which a SmCo nano particle having characteristics close to hydrophilicity is coated with a hydrophilic polymer, the SmCo magnetic fine particles are easily dispersed uniformly in a hydrophilic binder in the magnetic layer. In addition, the SmCo magnetic fine particle has extremely high uniaxial crystal magnetic anisotropy and has further fine SmCo nano particles (an average particle diameter of 1 nm or more and 100 nm or less) as a core, and accordingly, high magnetic characteristics can be imparted to the magnetic layer. Therefore, such a magnetic layer containing SmCo fine particles is extremely advantageous to having high recording density.

In the magnetic recording medium of the present invention, it is preferable that a molecular weight of the hydrophilic binder is larger than that of the hydrophilic polymer constituting the coating layer. Thereby, a magnetic layer becomes flexible, and if the number of SmCo magnetic fine particles is increased in order to deal with high recording density, durability of the magnetic recording medium can be sufficiently obtained.

The present invention also provides a preferable method for producing the magnetic recording medium of the present invention. That is, the method for producing a magnetic recording medium of the present invention is characterized by having a first step of obtaining a mixture containing a SmCo nano particle and a hydrophilic polymer by heating a reaction solution obtained by dissolving or dispersing a Sm salt, a Co salt and the hydrophilic polymer in a solvent; a second step of obtaining a magnetic coating material by adding a hydrophilic binder to the mixture; and a third step of forming a magnetic layer made of the SmCo magnetic fine particle having a core made of a SmCo nano particle and a coating layer made of the hydrophilic polymer and formed to coat at least a part of the surface of the core, and the hydrophilic binder, by using the magnetic coating material.

According to such a method for producing a magnetic recording medium of the present invention, the magnetic recording medium of the present invention capable of obtaining high recording density as described above and further having a hardly charged magnetic layer can be favorably obtained.

According to the present invention, it is possible to provide a magnetic recording medium capable of obtaining high recording density as described above and further having a hardly charged magnetic layer.

### BRIEF DESCRIPTION OF THE DRAWINGS

FIG. 1 is a view schematically showing a cross-sectional structure of the magnetic recording medium according to the preferable embodiment; and

FIG. 2 is a view schematically showing a cross-sectional structure of the SmCo magnetic fine particle 12.

### DESCRIPTION OF THE PREFERRED EMBODIMENTS

Hereinafter, a preferable embodiment of the present invention will be described in detail with reference to attached drawings. However, the present invention is not limited to the following embodiment. In addition, the same reference characters are given to the same elements, and repeated explanation is omitted in the description of the drawings.

### [Magnetic Recording Medium]

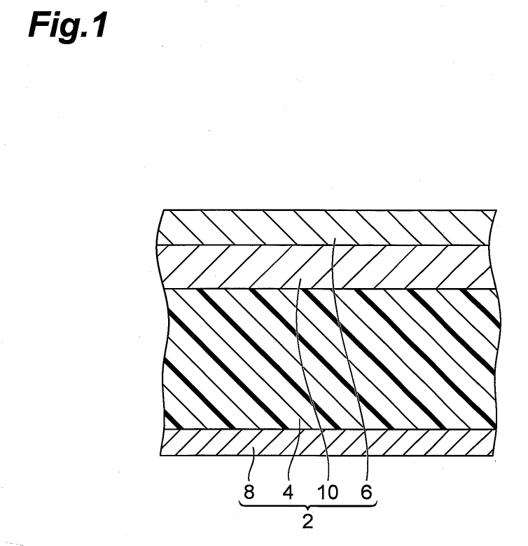

FIG. 1 is a view schematically showing a cross-sectional structure of a magnetic recording medium according to a preferable embodiment. As shown in FIG. 1, in the magnetic recording medium of the present embodiment (magnetic recording tape 2), a magnetic layer 6 is formed on one surface of a base film 4, and a back coat layer 8 is formed on the other surface. Further, an undercoat layer 10 is disposed between the base film 4 and the magnetic layer 6. In addition, the magnetic recording tape 2 may not necessarily have this undercoat layer 10. The magnetic recording tape 2 having such a structure is constituted so as to be able to reproduce recording of various recording data by a record reproduction device. Hereinafter, each structure of the magnetic recording tape 2 is described.

(Magnetic Layer 6)

The magnetic layer 6 contains a SmCo magnetic fine particle 12 and a hydrophilic binder. This magnetic layer 6 has a structure in which the hydrophilic binder is preferably uniformly distributed and the SmCo magnetic fine particles 12 are dispersed in this hydrophilic binder.

A center line average roughness Ra of a surface of the magnetic layer 6 is preferably 1 to 2 nm. When the center line average roughness Ra of the surface of the magnetic layer 6 is too small, the surface of the magnetic layer 6 is too flat and smooth and there is a tendency that running stability of the magnetic recording tape 2 deteriorates and trouble during running is likely to be caused. On the other hand, when the center line average roughness Ra of the surface of the magnetic layer 6 is too large, electromagnetic conversion characteristics such as reproduction output tend to deteriorate in a reproduction system using an MR type head. Thus, by setting the center line average roughness Ra of a surface of the magnetic layer 6 within the above described preferable range, these tendencies can be suppressed, and electromagnetic conversion characteristics of the magnetic recording tape 2 can be improved.

It is preferable that a thickness of the magnetic layer 6 is 0.01 to 0.08 μm. When the thickness of the magnetic layer 6 is too small, the number of SmCo magnetic fine particles 12 in the thickness direction of the magnetic layer 6 decreases, a magnetic flux density is lowered, and there is a tendency that carrier output is hardly obtained. Further, when the thickness of the magnetic layer 6 is too large, self-demagnetizing loss and thickness loss tend to be large. Thus, by setting the thickness of the magnetic layer 6 within the above described preferable range, these tendencies can be suppressed, and electromagnetic conversion characteristics of the magnetic recording tape 2 can be improved.

Herein, the SmCo magnetic fine particle 12 contained in the magnetic layer 6 will be described.

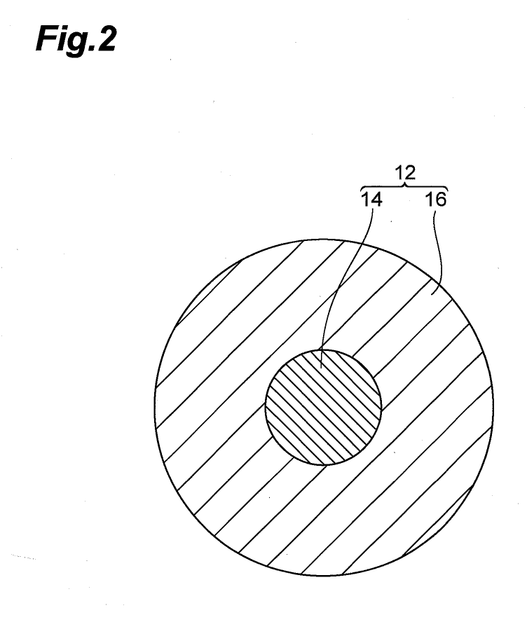

FIG. 2 is a view schematically showing a cross-sectional structure of the SmCo magnetic fine particle 12. As shown in FIG. 2, the SmCo magnetic fine particle 12 has a core 14 made of a SmCo nano particle and a coating layer 16 coating at least a part of the surface of the core 14. In addition, the coating layer 16 does not necessarily have a clear layered shape as shown in FIG. 1, and may have a structure such that a compound constituting the coating layer 16 is partially attached to the surface of the core 14.

The core 14 is constituted with a SmCo alloy. As the SmCo alloy, various alloys having different molar ratios of Sm and Co can be used. These SmCo alloys can be formed by suitably adjusting a charged amount of each material substance such as Sm and Co and reaction conditions at the time of synthesis thereof.

Since the core 14 is a nano particle, an average particle diameter thereof is defined to be 1 nm or more and less than 100 nm, and preferably 2 to 80 nm. When the average particle diameter of the core 14 is larger than 80 nm, there are tendencies that surface roughness of the magnetic layer 6 deteriorates, or a packing density of the SmCo magnetic fine particle 12 in the magnetic layer 6 is lowered, and thus, magnetic characteristics of the magnetic recording tape 2 in short wavelength recording are lowered. Further, when the average particle diameter of the core 14 is less than 2 nm, a ratio of a surface oxidation layer to a volume of the SmCo nano particle 14 becomes large, and thus, magnetic characteristics thereof tend to be lowered. Accordingly, by setting the average particle diameter of the core 14 within the range of 2 to 80 nm, these tendencies can be suppressed, and magnetic characteristics and electromagnetic conversion characteristics of the magnetic recording tape 2 can be improved.

In addition, a thickness of a magnetic layer of a general magnetic recording tape is 0.1 to 0.2 μm in a wet state, and a magnetic fine particle exceeding this film thickness has difficulty in its use. Therefore, it is necessary that an average particle diameter of a magnetic fine particle that can be used in a magnetic layer of a general magnetic recording tape is 0.1 μm (100 nm) or less. When a magnetic fine particle having an average particle diameter of more than 0.1 μm is used, since a center line roughness Ra of a surface of the magnetic layer becomes large, there is a tendency to cause defects such that a head is easily abraded due to contact with the magnetic layer surface, and also, by assuring an extra space between the tape (magnetic layer) and the head for protecting abrasion of the head, recording or output of reproduction is lowered. From the viewpoint of averting such a tendency, it is preferable that the average particle diameter of the SmCo nano particle 14 is set within the above described preferable range.

The core 14 is preferably spherical. When the core 14 is spherical, since a specific surface area is small as compared with the case of forming surface unevenness, and the like, oxidation of the core 14 is likely to be suppressed, and weather resistance of the magnetic recording tape 2 can be improved. Further, when the core 14 is spherical, the SmCo magnetic fine particle 12 is also spherical, which thus enables a packing density of the SmCo magnetic fine particle 12 in the magnetic layer 6 to be increased. Thereby, a recording density of the magnetic recording tape 2 can be further improved.

The coating layer 16 is constituted with a hydrophilic polymer. First, the hydrophilic polymer is a polymer having a group with high polarity or a group with electric charge in a molecule, and having high affinity to water. In particular, as the hydrophilic polymer, those having a structure in which a hydrophilic group with high polarity is bonded to one end of a hydrophobic molecular chain are preferable.

Examples of the hydrophilic polymer include poly(N-vinyl-2-pyrrolidone), polyacrylic acid, polymaleic acid, polyglutamic acid, and salts thereof, vinyl alcohol, polyethylene glycol, polypropylene glycol, polyacrylamide, polyvinylamine, polyethyleneimine, or derivatives thereof or copolymers thereof, cellulose, a water-soluble acrylic resin, water-soluble polyvinyl acetal, water-soluble polyvinyl butyral, and a water-soluble urethane resin. In addition, these hydrophilic polymers may have a structure crosslinkable each other.

An average molecular weight of a hydrophilic polymer is preferably 100 to 10,000. When the molecular weight of the hydrophilic polymer is too small, the synthesis thereof is difficult, and it tends to be hard to sufficiently coat the surface of the SmCo magnetic fine particle 12 with the hydrophilic polymer. On the other hand, when a molecular weight of the hydrophilic polymer is too large, it tends to be hard to dissolve the hydrophilic polymer 16 for a solvent contained in a coating solution for forming the magnetic layer 6, and a molecular chain of the hydrophilic polymer becomes too long, a plurality of cores 14 are easily adsorbed to one hydrophilic polymer, and as a result, dispersion of the SmCo magnetic fine particle 12 in the magnetic layer 6 may deteriorate in some cases. Thus, by setting the average molecular weight of the hydrophilic polymer within the above described preferable range, these tendencies can be suppressed, and in the magnetic layer 6, dispersibility of the SmCo magnetic fine particle 12 in a hydrophilic binder is to be improved.

Thus, when the coating layer 16 is formed with a hydrophilic polymer, a ratio of a hydrophilic substance of the magnetic layer 6 is increased, and electrification property can be more preferably reduced.

The coating layer 16 may coat at least a part of the core 14, and it is particularly preferable to coat the whole surface of the core 14 (attached over the whole surface). Thereby, oxidation of the SmCo nano particle constituting the core 14 is easily suppressed, weather ability of the magnetic recording tape 2 can be improved, and further, dispersibility of the SmCo magnetic fine particle 12 in the magnetic layer 6 can be also improved.

Then, a hydrophilic binder contained in the magnetic layer 6 will be described.

A hydrophilic binder can be used without any particular limitation as long as the hydrophilic binder has hydrophilicity and is a high-molecular compound capable of dispersing the SmCo magnetic fine particle 12. Examples of the hydrophilic binder include poly(N-vinyl-2-pyrrolidone), polyacrylic acid, polymaleic acid, polyglutamic acid, or salts thereof, vinyl alcohol, polyethylene glycol, polypropylene glycol, polyacrylamide, polyvinylamine, polyethyleneimine, or derivatives thereof or copolymers thereof, cellulose, a water-soluble acrylic resin, water-soluble polyvinyl acetal, water-soluble polyvinyl butyral, and an a water-soluble urethane resin. In addition, these hydrophilic binders may have a structure crosslinkable each other.

This hydrophilic binder may be the same hydrophilic polymer constituting the coating layer 16 of the SmCo magnetic fine particle 12, or may be different. In the case of being more suitable, the hydrophilic binder preferably has a larger molecular weight than that of the hydrophilic polymer constituting the coating layer 16. When the hydrophilic binder has a larger molecular weight than that of the hydrophilic polymer, the magnetic layer 6 on the whole is likely to be flexible, which thus results in being advantageous to readout of the magnetic recording tape 2 or improving durability of the magnetic recording tape 2. Specifically, a molecular weight of the hydrophilic binder is preferably 100 to 10,000.

The magnetic layer 6 may further contain a surfactant in addition to the SmCo magnetic fine particle 12 and a hydrophilic binder. In this case, the surfactant is preferably disposed so as to coat the SmCo magnetic fine particle 12 in the magnetic layer 6. As described above, the surfactant coating the SmCo magnetic fine particle 12 allows the SmCo magnetic fine particles 12 to more uniformly disperse in the hydrophilic binder. That is, the surfactant can function as a dispersant that disperses the SmCo magnetic fine particles 12 in the hydrophilic binder. Thus, when a surfactant is contained in the magnetic layer 6, weather resistance and electromagnetic conversion characteristics of the magnetic recording tape 2 can be improved. When the magnetic layer 6 contains a surfactant, adhesion between the magnetic layer 6 and the undercoat layer 10 can be improved, and further, rigidity of the magnetic layer 6 can be also improved.

As the surfactant, examples such as anionic surfactants, nonionic surfactants, and polymeric surfactants can be used. Examples of the anionic surfactants include sulfonic acid surfactants, and the like. Examples of the nonionic surfactants include fatty acid, fatty acid ester, alkylamine, and polyoxyethylene alkylamine surfactants. Examples of the polymeric surfactants include acrylic, urethane, vinyl alcohol, and vinylpyrrolidone surfactants. In addition, these surfactants may have a structure crosslinkable each other.

Among the above described surfactants, fatty acid surfactants, alkylamine based surfactants, or polymeric surfactants are preferable for dispersants that disperse the SmCo magnetic fine particles 12 in preparing a coating slurry for forming the magnetic layer 6. Further, fatty acid surfactants such as oleic acid and stearic acid, and alkylamine based surfactants such as oleylamine and stearylamine are preferable as surfactants from the viewpoint of cost. These surfactants may be used alone, or in combination. In addition, a sulfur compound such as thiol is also useful as a surfactant. However, since there is a possibility to cause corrosion of parts inside a tape drive depending on cases, it is preferable to use the surfactant as described above.

The magnetic layer 6 having the above described structure has a structure in which the SmCo magnetic fine particles 12 contained therein are dispersed in a hydrophilic binder, and this hydrophilic binder has characteristics that the magnetic layer 6 is hardly electrostatistically charged, and thus, it becomes extremely hard for the hydrophilic binder to be electrostatistically charged as the whole. Further, the SmCo magnetic fine particle 12 contained in the magnetic layer 6 has a core 14 made of a SmCo nano particle with high magnetic characteristics, and also, the surface thereof is coated with the coating layer 16, and thus, the SmCo magnetic fine particles 12 have high magnetic characteristics and are also uniformly dispersed in the magnetic layer 6. Therefore, it is easy for the magnetic layer 6 containing the SmCo magnetic fine particle 12 to have high recording density.

(Undercoat Layer 10)

Hereinafter, a structure other than the magnetic layer 6 in the magnetic recording tape 2 will be described. First, the undercoat layer 10 is disposed between the base film 4 and the magnetic layer 6, as described above. By having this undercoat layer 10, electromagnetic conversion characteristics of the magnetic recording tape 2 can be improved, and at the same time, adhesion between the base film 4 and the magnetic layer 6 can be improved.

The undercoat layer 10 is preferably a soft magnetic layer containing a soft magnetic material. The magnetic recording tape 2 provides a soft magnetic layer as the undercoat layer 10, thereby enabling perpendicular magnetic recording, and as compared with the case of conventional perpendicular magnetic recording, recording density of the magnetic recording tape 2 can be improved. In addition, as the soft magnetic material, a Fe alloy, a Co (cobalt) alloy, or the like can be used.

A center line average roughness Ra of the undercoat layer 10 is preferably 1 to 3 nm. When the center line average roughness Ra of the undercoat layer 10 is too large, since the center line average roughness Ra of the undercoat layer 10 gives an adverse effect on Ra of the magnetic layer 6 formed on the upper layer of the undercoat layer 10, output variation due to fluctuation in spacing between a head and a tape tends to be significant. When the center line average roughness Ra of the undercoat layer 10 is too small, since frictional force with a guide pin surface inside a drive is enhanced, running of the magnetic recording tape 2 tends to be unstable. Thus, by setting the center line average roughness Ra of the undercoat layer 10 within the above described preferable range, these tendencies can be suppressed, and electromagnetic conversion characteristics of the magnetic recording tape 2 can be improved.

A thickness of the undercoat layer is preferably 0.1 to 1.0 μm. Setting the thickness of the undercoat layer 10 within the range makes it possible to accumulate various additives enough to assure running durability of the magnetic recording tape 2. Furthermore, since adverse effects given to the magnetic layer 6 by the surface roughness of the base film 4 can be suppressed to minimum, errors in recording reproduction are easily reduced largely. Therefore, by setting the thickness of the undercoat layer 10 within the range from 0.1 to 1.0 μm, reliability of a produced magnetic recording tape can be preferably obtained.

(Base Film 4)

The base film 4 can be formed from materials such as polyester resins (e.g., polyethylene terephthalate and polyethylene naphthalate) and resin materials (e.g., polyamide, polyimide, and polyamideimide).

(Back Coat Layer 8)

The back coat layer 8 may be a layer having a known structure or composition that is applied to a back coat layer of a magnetic recording tape. Examples thereof include layers constituted with carbon black, a non-magnetic inorganic powder except for carbon black, a binder, and the like. By this back coat layer 8, running properties of the magnetic recording tape 2 can be improved, and at the same time, scratch (abrasion) of the base film 4 and electrification of the magnetic recording tape 2 can be prevented.

### [Method for Producing Magnetic Recording Tape 2]

Then, examples of a method for producing the magnetic recording tape 2 having the structure as described above will be described.

A method for producing the magnetic recording tape 2 is not particularly limited, and a known method for producing the magnetic recording tape 2 can be used. For example, a method includes a step of obtaining a mixture containing a SmCo nano particle and a hydrophilic polymer by heating a reaction solution obtained by dissolving or dispersing a Sm salt, a Co salt and the hydrophilic polymer in a solvent (the first step), a step of obtaining a magnetic coating material by adding a hydrophilic binder to the mixture (second step), and a step of forming a magnetic layer at least containing the SmCo magnetic fine particle 12 having a core 14 made of a SmCo nano particle and a coating layer 16 made of the hydrophilic polymer and formed to coat at least a part of the surface of the core, and the hydrophilic binder, by using the magnetic coating material (third step).

In the first step, the reaction solution is prepared by dissolving a Sm salt (samarium salt) and a Co salt (cobalt salt), and a hydrophilic polymer in a solvent such as glycols, and the like. As the samarium salt, a samarium acetylacetonate anhydride is preferable, and as the cobalt salt, cobalt acetylacetonate is preferable.

In the process of preparing the reaction solution, for example, the first solution is made by dissolving a samarium salt in the first solvent, the second solution is made by dissolving a cobalt salt in the second solvent, and the third solution is made by dissolving a hydrophilic polymer for forming a coating layer 16 in the third solvent in order to form a coating layer 16, and then, for instance, the first solution and the second solution are added to the third solution and can be mixed.

As the first, second and third solvents, for example, any of glycols such as ethylene glycol, diethylene glycol, triethylene glycol, tetraethylene glycol, pentaethylene glycol, 1,3-propanediol, 1,2-hexanediol, and 2-methyl-2,4-pentanediol can be used.

In particular, a solvent that can favorably dissolve a hydrophilic polymer is preferable as the third solvent, and a solvent having a boiling point at a comparatively high temperature (200 to 300° C.) is preferable from the viewpoint of enhancing crystallinity of the obtained SmCo nano particle 14. Further as the third solvent, those functioning as a reducing agent of a SmCo complex can be also used. When the third solvent without reduction ability is used, when a reduction reaction is promoted in the third solution, or the like, those dissolving a solid reducing agent such as LiAlH₄ or NaBH₄ in a suitable solvent may be added to the third solvent. Furthermore, in the case of forming a structure in which a surfactant is adsorbed to a SmCo nano particle, the surfactant can be also contained in the third solvent.

Then, after sufficiently stirring the above reaction solution, the mixture is maintained at about 110° C., and moisture is removed. Subsequently, the reaction solution is reacted while maintaining at 150 to 320° C. After this reaction is completed, the reaction solution is left to be stood until at room temperature, then solution conversion with dehydrated ethanol, and the like using an ultra filter and washing of particles are performed. Then, after the solvent is distilled off using an evaporator, finally by drying in vacuum, and the like, a mixture containing a SmCo nano particle 14 and a hydrophilic polymer that is a material of the coating layer 16 can be taken out as a solid powder.

Then, in the second step, the above mixture and a hydrophilic binder (binding agent) are dispersed in a solvent, and a magnetic coating material for forming the magnetic layer 6 is prepared.

In the magnetic coating material used for forming the magnetic layer 6, it is preferable to further contain a surfactant. In the magnetic layer 6 formed from a magnetic coating material containing a surfactant, the SmCo magnetic fine particles 12 are easily dispersed in the hydrophilic binder, whereby oxidation of the SmCo nano particle 14 by moisture can be further suppressed. Further, weather resistance and electromagnetic conversion characteristics of the magnetic recording tape 2 can be improved. Furthermore, in the magnetic layer 6 formed from a magnetic coating material containing a surfactant, rigidity thereof tends to be improved.

In the magnetic coating material, a known dispersant, lubricant, abrasive (head cleaning agent), curing agent, antistatic agent, and the like can be further added according to necessity. Further, when the magnetic coating material is prepared, high molecular weight polyurethane having a molecular weight of about 10,000 may be further added. Thereby, strength of a coating film of the magnetic recording tape 2 can be favorably obtained. Furthermore, a thermosetting agent such as Coronate 3041 made by Nippon Polyurethane Industry Co., Ltd. may be added as a curing agent. When this curing agent is contained, a strong crosslinkage is formed between the coating layer 16 coating the core 14 and a high molecular weight polyurethane, and strength of a coating film durable for high speed running can be imparted to the magnetic recording tape 2.

In production of the magnetic recording tape 2, in addition to the above described magnetic coating material, respective materials for forming the undercoat layer 10 and the back coat layer 8 are mixed, kneaded, dispersed, diluted, and the like, thereby producing a coating material for forming these layers, respectively.

Examples of a coating material for forming the back coat layer 8 and the undercoat layer 10 include those obtained by dispersing powder of constituting materials of each of these layers, binding agents, etc. in a solvent. In these coating materials, a dispersant, an abrasive, a lubricant, and the like, which are the same as used in the coating material for forming the magnetic layer 6 may be added according to necessity. For example, for forming the back coat layer 8, inorganic powders such as carbon black, α iron oxide, titanium oxide, calcium carbonate and α alumina, and a mixture thereof are used as a nonmagnetic powder. For forming the undercoat layer 10, a soft magnetic material such as a Fe alloy or a Co (cobalt) alloy may be used in place of a nonmagnetic powder.

Then, in the third step, the magnetic layer 6 is formed by using the above described magnetic coating material and the magnetic recording tape 2 is obtained. Specifically, for instance, a coating material for forming the undercoat layer 4 is coated on a surface of the base film 4, and a magnetic coating material for forming the magnetic layer 6 is coated thereon. Further, a coating material for forming the back coat layer 8 is coated on the surface opposite to the undercoat layer 10 of the base film 4. Thus, a laminate having a structure in which precursors of each of the layers are laminated is formed. Then, after performing orientation, drying, a calendaring treatment, and the like for the precursors of each of the layers according to necessity, a curing treatment of the precursors of each of the layers is carried out. Then, the laminate is cut into a desired shape or incorporated into a cartridge, thereby completing the magnetic recording tape 2.

The magnetic layer 6 of the thus obtained magnetic recording tape 2 has a structure in which a SmCo magnetic fine particle 12 having a core 14 made of a SmCo nano particle and a coating layer 16 made of a hydrophilic polymer and formed to cover at least a part of the surface of the core 14 are dispersed in a hydrophilic binder. In addition, in the production method of the present embodiment, the SmCo magnetic fine particle 12 is generated mainly in the first step, but may be generated in the second and third steps.

As described above, the magnetic recording tape 2 was described as a preferable embodiment of the magnetic recording medium according to the present invention, and since the magnetic recording tape 2 of the present embodiment has the above described magnetic layer 6, high recording density is possible, and also, the magnetic recording tape 2 has characteristics of being hardly charged.

Since a tape form magnetic recording medium (magnetic recording tape) is normally not adamant, it is hard to eliminate oscillation at the time of tape running. Therefore, the magnetic recording tape is constantly brought into contact with a head, thereby fixing the portion of the tape to suppress output variation, and thus, high density recording becomes possible. However, since a conventional magnetic recording tape is constituted by mixing a metal magnetic powder and a hydrophobic polymer in many cases, it is poor in electrical conductivity and tends to be easily charged by friction due to tape running.

However, in recent years, it has been essential to use a MR head in high density recording, in a system using this MR head, electrostatic discharge (ESD) is generated between a charged tape and the head, thereby destroying the head in some cases. In particular, further high density recording has proceeded recently, a head capable of corresponding to the further high density recording is also easily destroyed by electrostatic charge of a magnetic recording tape, and thus, a countermeasure to electrostatic charge has become more important.

Contrary to the above, the magnetic recording tape 2 of the present embodiment is extremely hardly charged because of having the magnetic layer 6 having the above described structure. Therefore, the magnetic recording tape 2 can be favorably used for a head corresponding to high density recording as described above, and destruction of these heads is less caused.

Hereinabove, the preferable embodiments of the present invention are described, however, the present invention is not necessarily limited to the above embodiments.

For example, in the above embodiments, the embodiment in which only one core 14 is contained per one SmCo magnetic fine particle 12 is explained, but there is no limitation to the embodiment, and the SmCo magnetic fine particle 12 may have a structure in which a plurality of cores 14 are dispersed in the coating layer 16. Further, for example, as described in the embodiment, the core 14 is preferably a single SmCo nano particle (primary particle), but may be a secondary particle formed from a plurality of SmCo nano particles.

The magnetic recording tape 2 of the above described embodiment has a structure in which the undercoat layer 10 is laminated on the base film 4 and the magnetic layer 6 is laminated on the undercoat layer 10, but a structure of the magnetic recording tape 2 is not limited thereto. For example, the magnetic recording tape may have a laminated structure in which a lower magnetic layer and an upper magnetic layer are sequentially laminated on a base film (support) or a laminated structure in which a nonmagnetic layer and a magnetic layer are sequentially laminated on a base film.

Further, the magnetic recording tape 2 may further have a soft magnetic layer containing a soft magnetic material between the base film 4 and the magnetic layer 6. By providing the magnetic recording tape 2 with a soft magnetic layer, perpendicular magnetic recording becomes possible, and as compared with the case of conventional longitudinal magnetic recording, recording density of the magnetic recording tape 2 can be further improved. In order to certainly obtain such an effect, it is preferable that the soft magnetic layer is adjacent to the magnetic layer 6. For example, the magnetic recording tape 2 in FIG. 1 may have a soft magnetic layer between the undercoat layer 10 and the magnetic layer 6. In addition, a Fe alloy, a Co alloy, or the like can be used as the soft magnetic material.

In the method for producing the magnetic recording tape 2 of the above described embodiment, after taking out a solid powder once from a reaction solution in the first step, a magnetic coating material is prepared using this solid powder in the second step, however, a preparation method of a magnetic coating material is not limited thereto. For example, in the first step, a solid powder is not taken out from a reaction solution, a solvent in the reaction solution is replaced with a solvent for a magnetic coating material, and a solid content concentration is suitably adjusted, and then in the second step, by adding a hydrophilic binder, etc, to the reaction solution, a magnetic coating material may be obtained. In addition, also in this case, it is preferable that after obtaining the reaction solution in the first step, a part of this reaction solution is removed by distilling off, or the like from the viewpoint of securing high reliability of recording reproduction characteristics by high output of a magnetic recording tape.

Further, as a magnetic recording medium, other than the magnetic recording tape 2 of the above described embodiment, known media such as a magnetic card and a magnetic disc can be also applied.

### EXAMPLES

Hereinafter, the present invention will be described further in detail by Examples, but the present invention is not limited to these Examples.

### Example 1

### Synthesis of SmCo Magnetic Fine Particle

A magnetic recording tape of Example 1 was produced as follows. First, 223.8 parts by weight of a samarium acetylacetonate hydrate ([CH₃COCH═C(O—)CH₃]₃Sm.xH₂O) was dissolved in 20,000 parts by weight of 1,4-dioxane to prepare a Sm solution. Then, 534.4 parts by weight of cobalt acetylacetonate ([CH₃COCH═C(O—)CH₃]₃Co) was dissolved in 20,000 parts by weight of 1,4-dioxane to prepare a Co solution. Further, 1,000 parts by weight of poly(N-vinyl-2-pyrrolidone) was dissolved in 90,000 parts by weight of tetraethylene glycol to prepare a polymer solution. In addition, poly(N-vinyl-2-pyrrolidone) is a hydrophilic polymer forming a coating layer in a SmCo magnetic fine particle that will be described later.

Then, the Sm solution and the Co solution were added to the polymer solution and mixed to prepare a reaction solution, and this reaction solution was mixed with stirring for 12 hours. Then, in order to remove moisture contained in a material of Sm salt and an alcohol solvent from the reaction solution after stirring, this reaction solution was kept at 110° C. under an inert gas flow, and heated for about 1 hour. Thereby, 1,4-dioxane used for dissolution of the Sm salt and Co salt was removed together, and the Sm salt and Co salt were transferred in the alcohol solvent of the reaction solution. Subsequently, the reaction solution was heated to reflux for about 3 hours at 250 to 300° C. under an inert gas flow to generate a chemical reaction. Thereby, a SmCo magnetic fine particle was generated in the reaction solution.

After this reaction solution was separated by a capillary and a solvent was substituted with anhydrous ethanol, the resultant solution was dropped to a TEM observation grid and dried. By TEM observation, it was confirmed that an average particle diameter of the synthesized SmCo magnetic fine particle was within the range of 2 to 7 mm.

Then, after the reaction solution was stood still and the supernatant was removed, a portion among hydrophilic polymers coating a core made of a SmCo nano particle in the SmCo magnetic fine particle is dissolved and removed by washing with adding acetone. Thereby, a weight ratio of a total weight of the SmCo nano fine particle to the hydrophilic polymers was set at about 6.

<Preparation of Coating Material for Magnetic Layer>

143 parts by weight of the above described slurry containing a SmCo magnetic fine particle (SmCo nano particle: 100 parts by weight, poly(N-vinyl-2-pyrrolidone): 14 parts by weight, acetone: 29 parts by weight, (weight ratio of SmCo nano particle to poly(N-vinyl-2-pyrrolidone) of 7/1, solid content concentration of 80% by weight), 2.7 parts by weight of polyvinyl alcohol (molecular weight: 10,000) that is a hydrophilic binder, 6 parts by mass of α-Al₂O₃, 2 parts by mass of phthalic acid, and butyl alcohol were added and blended together to prepare a slurry having a solid content concentration of 80% by weight, and the slurry was kneaded by a pressure kneader for 2 hours. Butyl alcohol was added to the slurry after kneading to form the slurry having a solid content concentration of 30% by weight, and then this slurry was subjected to a dispersion treatment by a horizontal pin mill filled with zirconia beads. To the slurry after the dispersion treatment, butyl alcohol, 1 part by mass of stearic acid, and 1 part by mass of butyl stearate were added to form the slurry having a solid content concentration of 10% by weight. To 100 parts by mass of this slurry, 0.82 part by mass of a water-soluble polyisocyanate compound (made by DIC Corporation) was added to thereby obtain a coating material for a magnetic layer.

<Preparation of Coating Material for Undercoat Layer>

A pressure kneader was charged with 85 parts by mass of needlelike α-Fe₂O₃, 15 parts by mass of carbon black, 15 parts by mass of an electron beam curing type vinyl chloride based resin, 10 parts by mass of an electron beam curing type polyester polyurethane resin, 5 parts by mass of α-Al₂O₃, 2 parts by mass of o-phthalic acid, 10 parts by weight of methyl ethyl ketone (MEK), 10 parts by weight of toluene, and 10 parts by weight of cyclohexene, and the mixture was kneaded for 2 hours to obtain a slurry. To the slurry after kneading, a mixed solvent (weight ratio of MEK/toluene/cyclohexanone=2/2/6) was added to form the slurry having a solid content concentration of 30% by weight, and then, this slurry was subjected to a dispersion treatment by a horizontal pin mill filled with zirconia beads for 8 hours. To the slurry after the dispersion treatment, a mixed solvent (weight ratio of MEK/toluene/cyclohexanone=2/2/6), 1 part by mass of stearic acid, and 1 part by mass of butyl stearate were added to form the slurry having a solid content concentration of 10% by weight, and a coating material for an undercoat layer was thus obtained.

<Preparation of Coating Material for Back Coat Layer>

A ball mill was charged with 50 parts by mass of nitrocellulose, 40 parts by mass of a polyester polyurethane resin, 85 parts by mass of carbon black, 15 parts by mass of BaSO₄, 5 parts by mass of copper oleate, and 5 parts by mass of copper phthalocyanine, and dispersion was carried out for 24 hours to obtain a mixture. A mixed solvent (weight ratio of MEK/toluene/cyclohexanone=1/1/1) was added to this mixture to form a slurry having a solid content concentration of 10% by weight. Subsequently, to 100 parts by mass of this slurry, 1.1 parts by mass of an isocyanate compound was added to form a coating material for a back coat layer.

<Preparation of Magnetic Recording Tape>

A coating material for an undercoat layer was coated on a surface of a polyethylene terephthalate film (base film) with a thickness of 6.1 μm so as to have a dry thickness of 2.0 μm, the film was dried, and then followed by a calendaring treatment, and finally, a coating film was cured by electron bean irradiation to form an undercoat layer. Then, a coating material for a magnetic layer was coated on a surface of the undercoat layer so as to have a dry thickness of 0.20 μm, a magnetic field orientation treatment was carried out, and the film was dried, then followed by a calendaring treatment to form a magnetic layer. Then, a fluorine solution (perfluoropolyether: 1 part by weight, n-hexane: 1,000 parts by weight) was coated on the magnetic layer and dried to form a water repellent layer.

Further, a coating material for a back coat layer was coated on the back face of the polyethylene terephthalate film so as to have a dry thickness of 0.6 μm, and the film was dried, and then followed by a calendaring treatment to form a back coat layer. Thus, a magnetic recording tape raw fabric in which each layer was formed on the polyethylene terephthalate film was obtained. Then, this magnetic recording tape raw fabric was placed into an oven and subjected to thermosetting at 60° C. for 24 hours. This magnetic recording tape raw fabric after thermosetting was cut into a width of ½ inch (12.65 mm) to obtain a magnetic recording tape of Example 1.

### Comparative Example 1

### Synthesis of SmCo Magnetic Fine Particle

A reaction solution containing a SmCo magnetic fine particle was obtained in the same manner as in Example 1, and then, this reaction solution was stood still and further filtered by an ultra filter to remove tetraethylene glycol. Then, by washing the obtained filtrated substance with dehydrated acetone, one portion among hydrophilic polymers coating a core made of a SmCo nano particle in the SmCo magnetic fine particle was dissolved and removed. Thereby, a weight ratio of a total weight of the SmCo nano particle to the hydrophilic polymer was set at 7/1.

<Preparation of Coating Material for Magnetic Layer>

143 parts by weight of the above described slurry containing a SmCo magnetic fine particle (SmCo nano particle: 100 parts by weight, poly(N-vinyl-2-pyrrolidone): 14 parts by weight, acetone: 29 parts by weight, (weight ratio of SmCo nano particle to poly(N-vinyl-2-pyrrolidone of 7/1, solid content concentration of 80% by weight), 2.7 parts by weight of high molecular weight urethane (UR8700: TOYOBO CO., LTD.) that is a hydrophobic binder, 6 parts by mass of α-Al₂O₃, 2 parts by mass of phthalic acid, and a mixed solvent (weight ratio of methyl ethyl ketone (MEK)/toluene/cyclohexanone=2/2/6) were added and blended together to prepare a slurry having a solid content concentration of 80% by weight, and the slurry was kneaded by a pressure kneader for 2 hours. To the slurry after kneading, a mixed solvent (weight ratio of MEK/toluene/cyclohexanone=2/2/6) was added to form the slurry having a solid content concentration of 30% by weight, and then, this slurry was subjected to a dispersion treatment by a horizontal pin mill filled with zirconia beads. To the slurry after the dispersion treatment, a mixed solvent (weight ratio of MEK/toluene/cyclohexanone=2/2/6), 1 part by mass of stearic acid, and 1 part by mass of butyl stearate were added to form the slurry having a solid content concentration of 10% by weight. To 100 parts by mass of this slurry, 0.82 part by mass of an isocyanate compound (Coronate L, made by Nippon Polyurethane Industry Co., Ltd.) was added to thereby obtain a coating material for a magnetic layer.

<Preparation of Coating Material for Undercoat Layer and Coating Material for Back Coat Layer>

A coating material for an undercoat layer and a coating material for a back coat layer were prepared in the same manner as in Example 1.

<Production of Magnetic Recording Tape>

A magnetic recording tape was obtained in the same manner as in Example 1, except that the coating material for a magnetic layer of Comparative Example 1 was used in place of the coating material for a magnetic layer of Example 1.

(Evaluation of Characteristics)

### <Evaluation of Electromagnetic Conversion Characteristics>

Electromagnetic conversion characteristics of the magnetic recording tapes of Example 1 and Comparative Example 1 were measured by recording at a recording wavelength of 0.2 μm with a MIG head and reproducing with a GMR head. In addition, a drum tester was used in the measurement of electromagnetic conversion characteristics. As a result of the measurement, preferable electromagnetic conversion characteristics were obtained from both of the magnetic recording tapes of Example 1 and Comparative Example 1.

<Evaluation of Electrification Property>

The magnetic recording tapes obtained in Example 1 and Comparative Example 1 were repeatedly run for a MR head in the same manner as in the case of recording and reproduction of these tapes. Then, a surface electric potential (V) and a surface charge amount (nC) of each magnetic recording tape were measured before running the magnetic recording tape and after running 10,000 times. The obtained Results are shown in Table 1.

TABLE 1

| | Surface electric | | Surface charge | |
|---|---|---|---|---|
| | potential (V) | | amount (nC) | |
| | Before | After running | Before | After running |
| | running | 10,000 times | running | 10,000 times |
| Example 1 | ~0 | 5 | ~0 | 0.1 |
| Comparative | ~0 | 10 | 0.1 | 0.3 |
| Example 1 | | | | |

As shown in Table 1, it was confirmed that the magnetic recording tape of Example 1 was hardly charged in recording and reproduction by using a MR head, and further confirmed that since a surface electric potential is small, recording and reproduction by a MR head can be stably conducted.

What is claimed is:

1. A magnetic recording medium comprising a magnetic layer comprising a SmCo magnetic fine particle and a hydrophilic binder, wherein the SmCo magnetic fine particle has a core comprising a SmCo nano particle and a coating layer comprising a hydrophilic polymer and formed to coat at least a part of the surface of the core.

2. The magnetic recording medium according to claim 1, wherein a molecular weight of the hydrophilic binder is larger than that of the hydrophilic polymer constituting the coating layer.

3. A method for producing a magnetic recording medium, comprising:
a first step of obtaining a mixture containing a SmCo nano particle and a hydrophilic polymer by heating a reaction solution obtained by dissolving or dispersing a Sm salt, a Co salt and the hydrophilic polymer in a solvent;
a second step of obtaining a magnetic coating material by adding a hydrophilic binder to the mixture; and
a third step of forming a magnetic layer comprising a SmCo magnetic fine particle having a core comprising a SmCo nano particle and a coating layer comprising the hydrophilic polymer and formed to coat at least a part of the surface of the core, and the hydrophilic binder, by using the magnetic coating material.
